(19) United States
(12) Patent Application Publication
(10) Pub. No.: US 2025/0241380 A1
(43) Pub. Date: Jul. 31, 2025

(54) CHARGING UNIT CONFIGURED TO OPERATE WITH AN AEROSOL GENERATING DEVICE, AND ASSOCIATED AEROSOL GENERATING ASSEMBLY AND OPERATION METHOD

(71) Applicant: JT INTERNATIONAL SA, Geneva (CH)

(72) Inventors: Layth Sliman BOUCHUIGUIR, Bellevue (CH); Pier Paolo MONTICONE, Le Grand Saconnex (CH)

(73) Assignee: JT INTERNATIONAL SA, Geneva (CH)

(21) Appl. No.: 18/880,856

(22) PCT Filed: Jul. 4, 2023
(86) PCT No.: PCT/EP2023/068389

§ 371 Date: Jan. 3, 2025

(30) Foreign Application Priority Data
Jul. 5, 2022 (EP) 22183125.8

(51) Int. Cl. A24F 40/95; A24F 40/60; H02J 7/00

(52) U.S. Cl. CPC A24F 40/95; A24F 40/60; H02J 7/0045

(57) ABSTRACT

The present invention concerns a charging unit configured to operate with an aerosol generating device. The aerosol generating device includes a device body extending along a device axis and defining at least one lateral wall. The charging unit includes a unit body defining an external surface and a recess portion formed in the external surface and configured to receive the aerosol generating device so as the lateral wall of the device body extends continuously with the external surface of the unit body. The charging unit further includes an ejecting mechanism configured to eject one end of the aerosol generating device from the recess portion of the charging unit upon a trigger event.

### FIELD OF THE INVENTION

The present invention concerns a charging unit configured to operate with an aerosol generating device. The present invention also concerns an aerosol generating assembly and an operation method associated to such a charging unit.

Particularly, according to the invention, the aerosol generating assembly comprises a charging unit and an aerosol generating device able to be received in the charging unit.

### BACKGROUND OF THE INVENTION

Different types of aerosol generating devices are already known in the art. Generally, such devices comprise a storage portion for storing a vaporizable material, which can comprise for example a liquid or a solid. A heating system is formed of one or more electrically activated resistive heating elements arranged to heat said vaporizable material to generate the aerosol. The aerosol is released into a flow path extending between an inlet and outlet of the device. The outlet may be arranged as a mouthpiece, through which a user inhales for delivery of the aerosol.

In some aerosol generating devices, the vaporizable material is stored in a removable cartridge. Thus, when the vaporizable material is consumed, the cartridge can be easily removed and replaced. In order to attach the removable cartridge to the device body, a screw-threaded connection can for example be used.

Some aerosol generating devices are configured to be stored in a case. Such a case may be adapted to receive an aerosol generating device, eventually with or without a removable cartridge. This can simplify carrying of the device and protect it for example against shocks. Some cases can also prevent leakage of the vaporizable material contained in the cartridge.

According to some examples, the case can be provided with a rechargeable battery able to recharge the battery of the aerosol generating device when for example an external power source is not available. Such a case can be called charging unit. According to additional examples, the case can allow the device power connection to an external power source and/or device data connection with an external device.

Some charging units are provided with a lid or other type of doors giving access to the aerosol generating device and ensuring its secured storing inside the charging unit. Thus, the user has to open first the lid in order to be able to grab the device.

According to some examples, charging units can be provided with means facilitating grabbing the aerosol generating device by the user. For examples, some charging units can be provided with a slant to eject the aerosol generating device from the charging unit.

Different means allowing secure storing and/or grabbing and/or ejecting of the aerosol generating device make the charging unit cumbersome and not suitable for carrying by the user together with the aerosol generating device for example as a portable device.

### SUMMARY OF THE INVENTION

One of the aims of the present invention is to provide a charging unit of reduced dimensions and weight. The charging unit can thus be carried by the user together with the aerosol generating device without any difficulty.

For this purpose, the invention concerns a charging unit configured to operate with an aerosol generating device;

the aerosol generating device comprising a device body extending along a device axis between two ends, the device body defining at least one lateral wall of the aerosol generating device;

the charging unit comprising a unit body defining an external surface and a recess portion formed in the external surface and configured to receive the aerosol generating device so as the lateral wall of the device body extends continuously with the external surface of the unit body;

wherein the charging unit further comprises an ejecting mechanism configured to eject one end of the aerosol generating device from the recess portion of the charging unit upon a trigger event.

Thank to these features, no specific mean facilitating grabbing the device is necessary. The user can thus grab directly the end of the aerosol generating device which is ejected from the recess portion of the charging unit.

Preferably, the ejecting mechanism according to the invention is electrically powered, for example by a battery comprised in the charging unit. Such an ejection mechanism can be particularly compact that further reduces the dimensions and weight of the charging unit.

Additionally, since in the received position, the lateral wall of the device body extends continuously with the external surface of the unit body, the aerosol generating device can be extracted from the charging unit using only the ejecting mechanism. Particularly, since no specific recess or gap is provided between the lateral wall of the device body and the external surface of the unit body, the only possibility for the user to extract the aerosol generating device is actuating the ejecting mechanism via the trigger event. This can for example prevent from using the aerosol generating device by a child or any other unauthorized person. Thus, the aerosol generating device can be securely stored inside the charging unit. This also means that the charging unit is free of lid or any other covering element for securing access to the aerosol generating device.

According to some embodiments, the trigger event comprises activation of a button by a user.

Thanks to these features, the user can easily actuate the ejecting mechanism. The button can for example be arranged on the unit body and present any appropriate shape and form. For example, the button can be either mechanical (push-button for example) or touch-button. According to other examples, the button can be arranged on the device body and like in the previous case, present either mechanical or touch-button. In these other examples, the dimensions and weight of the charging unit are further reduced.

Alternatively or additionally, the trigger event may be generated by a controller, for example a controller comprised either in the charging unit or in the aerosol generating device. For example, the controller can generate such a trigger event further to an action of the user performed in relation with the charging unit and/or aerosol generating device.

In some embodiments, the trigger event further comprises a successful authentication of a user.

In such a case, the controller of the aerosol generating device or of the charging unit can be configured to perform an authentication process of the user. This process may comprise user authentication using for example authentication data (such as user name, password, identifier, etc.) or bio-data. The bio-data can for example comprise user fingerprint which may be detected by a sensor arranged on the unit body. Additionally or alternatively, user authentication can for example comprise sending an authentication signal from an external device, such a smartphone.

Thanks to these features, the aerosol generating device can be ejected from the charging unit and be able to generate vapor only when the user passes successfully the authentication. This prevents from using the aerosol generating device by an unauthorized user such for example a child.

According to some embodiments, the ejecting mechanism is configured to be powered upon the trigger event to eject said end of the aerosol generating device;

preferably, the ejecting mechanism being configured to be powered during a predetermined time period to maintain said end of the aerosol generating device in an ejected position.

Thanks to these features, the triggering event can trigger powering of the ejecting mechanism for example by the battery of the charging unit. Alternatively or additionally, the battery of the aerosol generating device can power the ejecting mechanism. Advantageously, the aerosol generating device can be in the ejected position as long as the ejecting mechanism is powered. If the aerosol generating device is not grabbed by the user during the predetermined time period, the powering of the ejecting mechanism can be stopped and the aerosol generating device can return to its received position into the charging for example by action of retaining mechanism or for example by gravity. Alternatively, the user can insert it back into the recess portion by a manual action. The predetermined time period can last few seconds, for example 4 or 5 seconds. It can also be configured by the user.

According to some embodiments, the charging unit further comprises a retaining mechanism configured to retain at least one end of the aerosol generating device or the whole device body within the recess portion of the charging unit.

Thanks to these features, it is possible to retain the aerosol generating device in the recess portion. According to different embodiments, the retaining mechanism can be configured to retain the whole device in the recess portion or only one of its ends. In the first case, the retaining mechanism can be actuated when for example the rejecting mechanism is not powered. This is can secure the aerosol generating device in the received position and prevents for example from using the aerosol generating device by an unauthorized user. In the second case, the retaining mechanism can for example be actuated simultaneously with the ejecting mechanism. In this case, one end of the aerosol generating device can be ejected from the recess portion and the other end retained in the recess portion. This ensures a stable position of the aerosol generating device in the ejected state, before it is grabbed by the user.

According to some embodiments, the retaining mechanism comprises a ferromagnetic element or magnetic element arranged in the unit body so as to create attraction with a magnetic element comprised in the device body.

Thanks to these features, the retaining mechanism can present a simplified structure. In some examples, the magnetic element in the device body can be formed by a permanent magnet which attracts the corresponding ferromagnetic or magnetic element arranged in the unit body. In case of the ferromagnetic element in the unit body, it can be made from any ferromagnetic material able to be attracted by the permanent magnet. In case of the magnetic element in the unit body, it can be formed by a permanent magnet. According to these examples, the retaining mechanism does not need to be powered so as it can act permanently when the aerosol generating device is received in the recess portion.

According to some embodiments, the ejecting mechanism comprises a first magnetic element arranged in the unit body to face a second magnetic element arranged in the device body, the first magnetic element being configured, when powered, to repel the second magnetic element;

wherein the first magnetic element is a coil configured to generate a magnetic field repelling the second magnetic element.

Thanks to these features, the ejecting action by the ejecting mechanism can be realized by activating a magnetic field by the charging unit and repelling the second magnetic element by the magnetic field. The second magnetic element can be formed by a permanent magnet or another magnetic coil.

According to some embodiments, the ferromagnetic element of the retaining mechanism forms an electromagnetic core of said coil of the ejecting mechanism;

preferably, the retaining mechanism being configured to retain the whole device body within the recess portion of the charging unit when the ejecting mechanism is not powered.

Thanks to these features, the ejecting and retaining mechanisms can be combined to form a same structure. Thus, when the coil is not powered, the ferromagnetic element can be attracted by the second magnetic element which is comprised in the device body, so as to retain together the device body and the unit body. When the coil is powered, the magnetic field created by the coil can be configured to surpass the attracting force created between the second magnetic element and the ferromagnetic element to repel the second magnetic element. Thus, ejecting force is created.

According to some embodiments, the ejecting mechanism comprises a shape memory alloy spring able to expand when powered and a plunger mounted on said spring and able to repel said end of the aerosol generating device.

Thanks to these features, the ejecting force can be achieved while expanding of the shape memory alloy spring. The plunger can be abutted directly against the device body so as no additional element in the aerosol generating device is needed to create the ejecting action.

According to some embodiments, the retaining mechanism is configured to retain the non-ejected end of the aerosol generating device within the recess portion of the charging unit.

Thanks to these features, a stable position of the aerosol generating device can be achieved in the ejected state of the aerosol generating device.

According to some embodiments, the ejecting mechanism further comprises a biasing element configured to bias the shape memory alloy spring to its initial position after having been expanded.

Thanks to these features, the shape memory alloy spring can take its initial shape automatically when it is not powered. The plunger can thus return to its initial position without any additional action from the user.

The present invention also relates an aerosol generating assembly, comprising:
an aerosol generating device;
a charging unit according as defined above.

According to some embodiments, the aerosol generating device further comprises a user interface.

The user interface can be used to display and/or input data/commands while the aerosol generating device is received in the recess portion of the charging unit and is for example being charged by this last one. Since at least the lateral wall of the aerosol generating device is kept uncovered, such a user interface can be directly arranged on this lateral wall and there is no need to provide a separate user interface on the charging unit. This can simplify the structure of the charging unit and make it more compact.

According to some embodiments, the user interface is adapted to display at least one of the following data elements:
an indicator indicating whether the aerosol generating device is received within the charging unit or not;
an indicator indicating a charging process of the aerosol generating device by the charging unit;
an indicator indicating results of an authentication process;
an indicator indicating the progress of heating of a vaporizable material;
an indicator indicating the remaining capacity of heating the vaporizable material without charging of a battery comprised in the aerosol generating device;
an indicator indicating the remaining capacity of the battery of the aerosol generating device;
an indicator indicating the remaining capacity of a battery of the charging unit;
an indicator indicating a charging process of the battery of the charging unit by an external power source.

Thanks to these features, the user can be provided with useful information about device using and/or charging process and/or authentication process.

The present invention also relates an operation method of an aerosol generating assembly as defined above, comprising the following steps:
detect the trigger event;
power the ejecting mechanism to eject one end of the aerosol generating device from the recess portion of the charging unit.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic face view of an aerosol generating assembly according to the invention, the aerosol generating assembly comprising a charging unit and an aerosol generating device received in the charging unit;

FIG. 2 is a cross-sectional view according to plane II-II′ of the aerosol generating assembly of FIG. 1, the aerosol generating device being extracted from the charging unit, the charging unit comprising a rejecting mechanism and a retaining mechanism;

FIG. 3 is a schematic view of the rejecting and retaining mechanisms of FIG. 2, according to a first embodiment of the invention;

FIG. 4 is a schematic view of the rejecting and retaining mechanisms of FIG. 2, according to a second embodiment of the invention; and

FIG. 5 is a schematic view of the rejecting and retaining mechanisms of FIG. 2, according to a third embodiment of the invention.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” or “aerosol forming substance” or “substance” is used to designate any material that is vaporizable in air to form aerosol. Vaporization is generally obtained by a temperature increase up to the boiling point of the vaporization material, such as at a temperature less than 400° C., preferably up to 350° C. The vaporizable material may, for example, comprise or consist of an aerosol-generating liquid, gel, wax, foam or the like, an aerosol-generating solid that may be in the form of a rod, which contains processed tobacco material, a crimped sheet or oriented strips of reconstituted tobacco (RTB), or any combination of these. The vaporizable material may comprise one or more of: nicotine, caffeine or other active components. The active component may be carried with a carrier, which may be a liquid. The carrier may include propylene glycol or glycerin. A flavoring may also be present. The flavoring may include Ethylvanillin (vanilla), menthol, Isoamyl acetate (banana oil) or similar.

As used herein, the term “external device” may refer to a device, which is able to establish a wireless data connection with the aerosol generating device as it is explained in the specification. Such an external device may be a mobile device like a mobile phone for example. Additionally, such an external device may be a smart device able to process at least some data received from the aerosol generating device or intended to be transmitted to the aerosol generating device. Such a smart device can be a smartphone, a smartwatch, a tablet computer, a laptop, a desktop computer or any other smart object implemented for example according to the IoT (“Internet of things”) technology. Such a smart device can be also another aerosol generating device similar to said aerosol generating device.

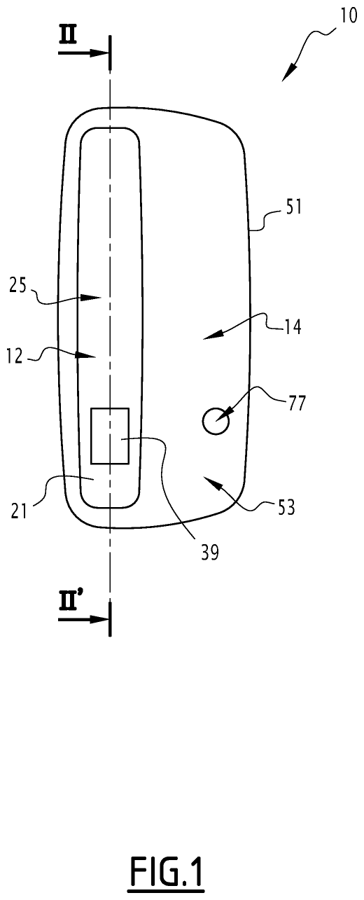

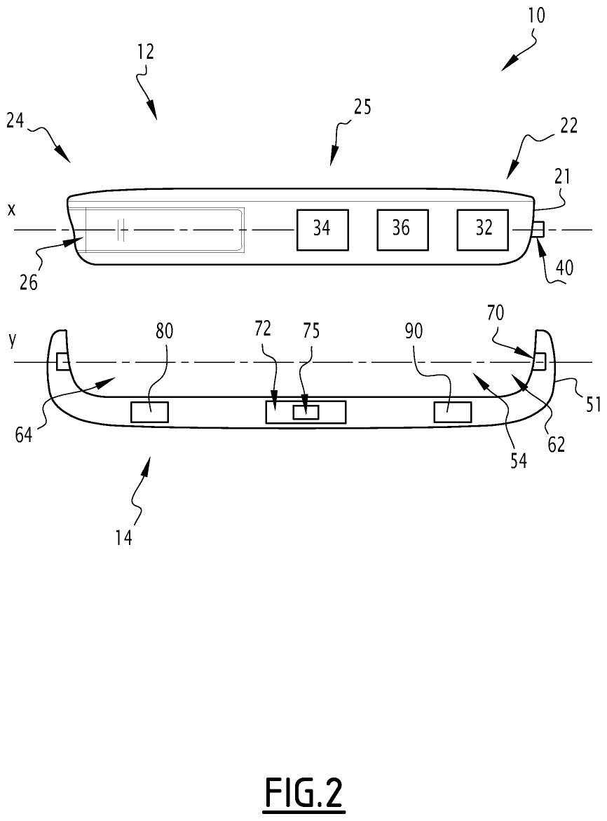

Referring to FIG. 1, an aerosol generating assembly 10 according to the invention comprises an aerosol generating device 12 and a charging unit 14 configured to operate with the aerosol generating device 12. Particularly, the charging unit 14 is configured to store and charge the aerosol generating device 12. These elements 12, 14 are shown in more detail in FIG. 2 where the aerosol generating device 12 is extracted from the charging unit 14.

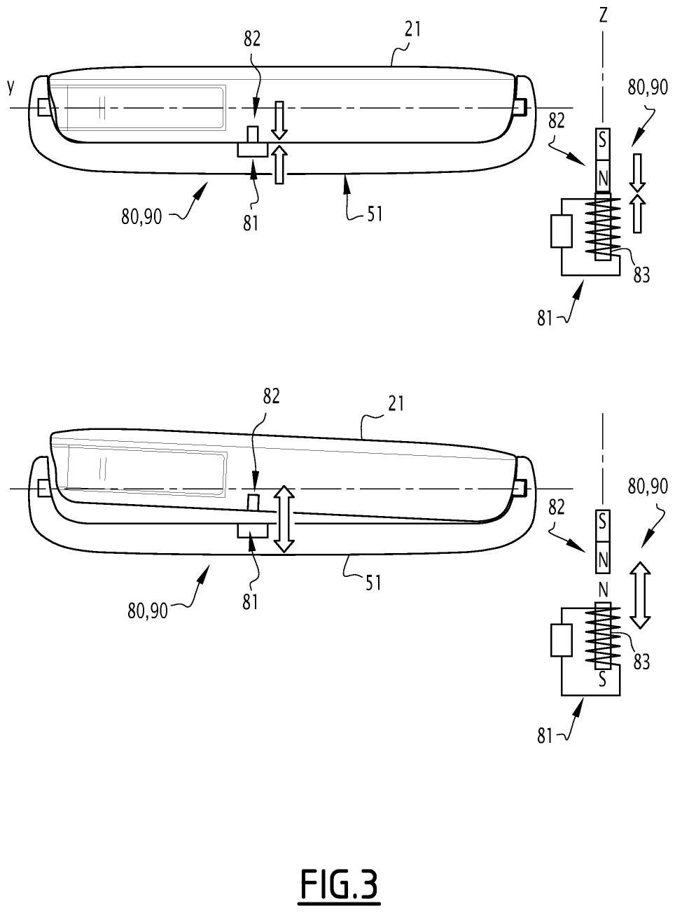

In reference to these FIGS. 2 and 3, the aerosol generating device 12 comprises a device body 21 extending between a battery end 22 and a mouthpiece end 24 along a device axis X. The device body 21 can form a cylindrical shape with for example a round, elliptic or rectangular cross-section. The device body 21 further defines a lateral wall 25 extending along the device axis X. Depending on the cross-sectional shape of the device body 21, the lateral 25 wall can be formed by one or several external surfaces.

The mouthpiece end 24 comprises for example a mouthpiece (not shown in figures) which is intended to cooperate with the user's mouth. The battery end 22 is for example usable by the user to hold the device 12 while it is being used to generate vapour. Particularly, the battery end 21 can form an appropriate ergonomic shape to be held by the user while using the aerosol generating device 12.

Referring to FIG. 2, the device body 21 defines a storage portion 26 designed to store a vaporisable material. Particularly, according to one embodiment of the invention, this storage portion 26 is designed to receive a removable cartridge, which is designed to store the vaporisable material. Thus, according to this embodiment, the cartridge can be received in the storage portion 26 and when the vaporisable material is exhausted, it can be replaced by another cartridge. The vaporizable material can be either in liquid form or at least partially in solid form. In the first example, the cartridge defines a reservoir able to store the liquid vaporizable material. In the second example, the cartridge can present a tobacco stick or any other suitable shape comprising shredded and/or compressed tobacco leafs. In some cases, the cartridge can define a mouthpiece and form at least partially the mouthpiece end 24 of the device 12. According to another embodiment of the invention, the storage portion 26 is designed to be filled directly with a vaporisable material, through for example a suitable opening. In this case, when the vaporisable material is exhausted, the storage portion 26 can be refilled by the vaporisable material.

The device body 21 delimits an internal part of the aerosol generating device 12, which comprises for example a power block 32 designed to power the device 12, a heating system 34 designed to heat the vaporisable material comprised in the storage portion 26, and a controller 36 designed to control the operation of the aerosol generating device 12. The device body 21 may further comprise other internal components performing various functionalities of the device known in the art.

It should be noted that FIG. 2 presents only a schematic diagram of different components of the aerosol generating device 12 and does not necessarily show the real physical arrangement and dimensions of these components. Particularly, such an arrangement can be chosen according to the design of the aerosol generating device 12 and the technical features of its components.

The power block 32 comprises a battery and a battery charger. The battery is for example a known battery designed to be charged using the power supply furnished by an external source, and provide a direct current DC. The battery charger is able to connect the battery to the external source and control the power delivered from the external source to the battery according for example a pre-determined charging profile (e.g., constant-current-constant-voltage profile). Such a charging profile can for example define a charging voltage of the battery depending on its level of charge.

To electrically connect the battery to the external source, according to one embodiment of the invention, the battery charger comprises a power connector 40 shown in FIG. 2. The power connector 40 can correspond to any known connector and can be arranged on a transverse wall of the device body 21 which is substantially perpendicular to the device axis X and is arranged on the battery end 22 of the device body 21. Particularly, the power connector 40 can protrude from this transverse wall or can be recessed in this wall. According to other embodiments, the power connector 40 may be arranged on any other wall. Advantageously, the power connector 40 can be provided with any suitable mean facilitating its connection with an external connector and/or disconnection from it. Such a mean can be formed by a magnetic element. Advantageously, the power connector 40 is configured to be connected to an external connector without being engaged inside it and without receiving at least a part of this external connector. In this case, connection between the connectors may be performed by cooperation of contacting surfaces of both connectors. In order to maintain the connection and make it reliable, at least one of the connectors can be pushed towards the other connector using suitable pushing means. Such pushing means can be integrated into the aerosol generating device 12 and/or the charging unit 14. Advantageously, the operation of the pushing means can be deactivated further to a trigger event, as it will be explained in further detail below. In some embodiments, the power connector 40 can be used for purposes other than charging purposes, as for example data transmitting purposes. In this case, it can be connected directly to the controller 36.

According to some embodiments of the invention, the battery charger may also be adapted to charge wirelessly the battery of the device 12, using for example a magnetic cooperation between a pair of coils as it is known per se. In this case, the power connector 40 may be provided as previously explained or may be used only for other purposes, as for example data transmitting purposes. According to still another example, no connector is provided with the aerosol generating device 12.

The heating system 34 is connected to the power block 32 through the controller 36. Various types of components known in the art may form the heating system 34. Thus, according to one embodiment of the invention, the heating system 34 may comprise a wick arranged in the storage portion 26 and a heating element arranged around the wick and connected to the power block 32 through the controller 36. In this case, the liquid vaporisable material can be vaporized by passing through the wick while it is heated by the heating element. According to another embodiment of the invention, the heating system 34 may comprise one or several heating plates. In this case, the heating plates may form walls of the storage portion 26 and be connected to the power block 32 to heat the at least partially solid vaporizable material. Alternatively or additionally, the heating plate may form protrusion which protrudes from the storage portion 26. According to still another embodiment of the invention, the heating system 34 may heat the vaporizable material by electromagnetic interaction between one or several susceptors and an electromagnetic coil.

The controller 36 is able to control the operation of the aerosol generating device 12. Particularly, the controller 36 is configured to power the heating system 34 of the device to generate vapour from the vaporisable material. The controller 36 can be activated by the user via a vaping button or further to detection of a user puff, for example by a pressure sensor disposed in an airflow path of the aerosol generating device 12. The controller 36 may perform any other functionality of the device 12 known per se. Such functionality may for example concern a communication capacity of the device 12 with an external device, a maintenance capacity, an analysis capacity, etc. The controller 36 may comprise one or several integrated circuits and several electrical parts. Such an integrated circuit may comprise at least one of MCU (microcontroller unit) or MPU (micro processing unit).

According to some embodiment of the invention, the aerosol generating device 12 further comprises a user interface 39 arranged on the lateral wall 25 of the device body 21. The user interface 39 is connected to the controller 36 and is able to input/output data to/from the controller 36. For example, the user interface 39 can comprise a display adapted to display at least one of the following data elements:
an indicator indicating whether the aerosol generating device 12 is received within the charging unit 14 or not;
an indicator indicating a charging process of the aerosol generating device 12 by the charging unit 14;
an indicator indicating results of an authentication process as it will be explained in further detail below;
an indicator indicating the progress of heating for the vaporizable material comprised in the storage portion 26;
an indicator indicating the remaining number which can perform the heating for the vaporizable material comprised in the storage portion 26 without charging of the battery comprised in the power block 32;
an indicator indicating the remaining amount of the battery of the aerosol generating device 12;
an indicator indicating the remaining amount of the battery of the charging unit 14;
an indicator indicating a charging process of the charging unit 14 by the external power source.

In some embodiments, the user interface 39 comprises input means, such for example a touchpad, able to acquire at least some commands from the user. These commands can par example be relative to the authentication process. In some embodiments, the user interface 39 may further comprise a bio-data sensor, such for example a fingerprint sensor.

The charging unit 14 defines a unit body 51 defining an external surface 53 and a recess portion 54 formed in the external surface 53 and configured to receive the aerosol generating device 12 so as the lateral wall 25 of the device body 21 extends continuously with the external surface 53 of the unit body 51. Particularly, by continuous extension of the lateral wall 25 and the external surface 53, it is understood that the thickness of the gap formed between these elements along the whole border of the recess portion 54 is less than a predetermined threshold. This threshold can be comprised for example between 0,5 and 4 mm. Advantageously, the threshold is chosen to not allow a user finger to grab the device body 21 when it is received in the recess portion 54 while allowing an ease insertion of the device body 21 despite for example possible manufacturing imprecisions and/or material dilatations. The lateral wall 25 and the external surface 53 can for example have a design ensuring a smooth transition between these elements when the device body 21 is received in the recess portion 54.

The recess portion 54 extends along a recess axis Y. The recess portion 54 is adapted to receive the aerosol generating device 12, so that the device axis X coincides with the recess axis Y. Particularly, the recess portion 54 extends along the recess axis Y between a first end 62 and a second end 64. The first end 62 and the second end 64 are adapted to receive respectfully the battery end 22 and the mouthpiece end 24 of the aerosol generating device 12. For this purpose, in the embodiment of the Figures, the first end 62 of the recess portion 54 can comprise a connector 70 configured to cooperate with the power connector 40 of the aerosol generating device 12, as explained above. Depending on the nature of the power connector 40, the connector 70 of the charging unit 14 may be adapted to transmit power to the device 12 or data to this device 12. In some embodiments, the first end 62 of the recess portion 54 may comprise a foam or any other suitable material preventing leakage from the mouthpiece when the aerosol generating device 12 is received in the recess portion 54.

The unit body 51 of the charging unit 14 defines an internal part comprising notably an electric circuitry 72. According to some embodiments, the electric circuitry 72 comprises a charging circuit able to provide to the aerosol generating device 12 an electric power supply. For this purpose, the charging circuit may comprise a rechargeable battery and a charger able to charge the battery of the aerosol generating device 12 wirelessly and/or via the connectors 40, 70. The charging circuit may further comprise electric connection means making it possible to connect the battery comprised in this circuit and/or charger to an external power source. For example, the charging circuit may define for this purpose an external connector. This external connector is arranged for example on an external surface of the unit body 51.

According to the invention, the electric circuitry 72 further comprises a control module 75, called controller in some cases, able to implement an ejecting capacity of the charging unit 14, further to a trigger event. The trigger event may consist in actuating of a button by the user. In this case, the charging unit 14 may for example comprise a button 77 arranged for example on the external surface 53 of the unit body 51. The button 77 can for example be mechanical or a touch-button. The control module 75 may comprise one or several integrated circuits and several electrical parts as well as the controller 36. Such an integrated circuit may comprise at least one of MCU (microcontroller unit) or MPU (micro processing unit).

Alternatively or additionally, the trigger event may comprise a successful authentication of a user further to an authentication process. The authentication process can for example be performed using the button 77 on the external surface 53 and/or the user interface 39 of the aerosol generating device 12. For example, the authentication process can comprise verification of user data, such identifier, name, password, and/or bio/data such for example user fingerprint. For this last purpose, a fingerprint sensor can be arranged in the button 77 and/or in the user interface 39 as explained before.

According to another example, the trigger event may consist in any other event that may be detected by the electric circuitry 72. For example, the trigger event may consist in receiving of a special command from an external device connected to the electric circuitry 72 of the charging unit 14. According to another embodiment, the trigger event may consist in receiving of a special command from the device 12 using for example the connectors 40 and 70.

According to the invention, the charging unit 14 further comprises an ejecting mechanism 80 configured to eject at least one end of the device 12 upon a trigger event. In some embodiments, the charging unit 14 further comprises a retaining mechanism 90 configured to retain at least one end of the aerosol generating device 12 or the whole device within the recess portion 54.

These mechanisms 80, 90 can be implemented according to different embodiments which will now be explained in reference to FIGS. 3 to 5.

### FIRST EMBODIMENT

According to the first embodiment shown in FIG. 3, the ejecting and retaining mechanisms are integrated into a same ejecting/retaining mechanism 80, 90. Particularly, according to this embodiment, the ejecting/retaining mechanism 80, 90 comprises a first magnetic element 81 configured to repel, further to a trigger event, a second magnetic element 82 integrated into the device body 21. As it is shown in FIG. 3, the first magnetic element 81 is arranged facing the second magnetic element 82 when the device 12 is received in the recess portion 54. Both magnetic elements 81, 82 can be arranged for example closer to the mouthpiece end 24 than to the battery end 22 of the device body 21. In this case, the ejecting action is exerted on the mouthpiece end 24 of the device body 21. Advantageously, each of the magnetic elements 81, 82 is arranged inside the corresponding body 21, 51 and is able to interact with the other magnetic element through the corresponding walls.

According to the preferred embodiment of the invention, the second magnetic element 82 presents a permanent magnet and the first magnetic element 81 presents an electromagnet, for example a flat-shaped electromagnet. This electromagnet comprises a coil arranged along an axis perpendicular to the axis Y, called hereinafter coil axis Z. The coil is connected to the electric circuitry 72 and notably to the control module 75 which is able to control its operation. Particularly, the control element 75 is able to power the coil to create a magnetic field inside the coil along the coil axis Z. The magnetic field along the coil axis Z has the same polarity as the external surface of the second magnetic element 82 when it is formed by a permanent magnet.

Particularly, as it is shown in the bottom part of FIG. 3, the coil is powered by the control module 75 to create a magnetic field along the coil axis Z repelling the second magnetic element 82. In this example, the magnetic field has the North polarity. The control module 75 is thus able to power the first magnetic element 81 to repel the second magnetic element 82. In some cases, the control module 75 is able to power the first magnetic element 81 to repel the second magnetic element 82 according to a predetermined profile. For example, according to this profile, the coil may be powered with a delay after the detection of a trigger event. The profile may also vary the power delivered to the coil for example to adapt the speed of repelling and thus, achieve a particular visual effect for the user. In some other embodiments, the control module 75 is configured to power the first magnetic element 81 during a predetermined time period. Thus, if the user did not grab the device 12 within this time period, the repelling action disappears and the device 12 can be attracted into its initial position due to the retaining action.

According to the first embodiment, the ejecting/retaining mechanism 80, 90 further comprises a ferromagnetic element 83 arranged within the coil to form an electromagnetic core. The ferromagnetic element is designed to be attracted by the second magnetic element 82 as it is shown in the top part of FIG. 3. Thus, when the coil is not powered, the device body 21 can be attracted to the unit body 51 by magnetic interaction between the ferromagnetic element 83 and the second magnetic element 82.

### SECOND EMBODIMENT

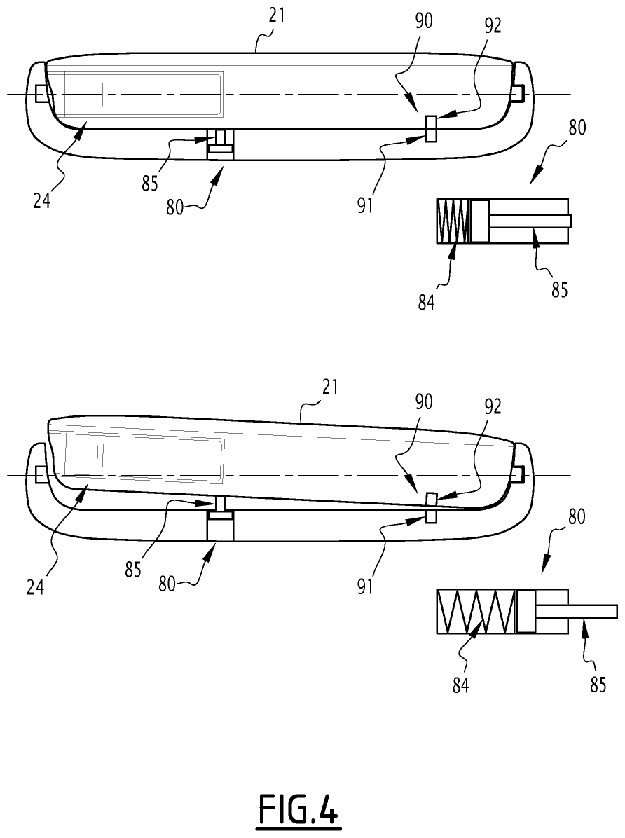

According to the second embodiment shown in FIG. 4, the ejecting and retaining mechanisms 80, 90 form two different structures.

According to this embodiment, the ejecting mechanism 80 comprises a shape memory alloy spring 84 able to expand when powered by the control module 75 and a plunger 85 mounted on said spring and able to repel one of the ends of the aerosol generating device 12. In the example of FIG. 4, the plunger 85 is able to repel the mouthpiece end 24 of the device 12, as it is shown in the bottom part of this figure. As in the previous case, the memory alloy spring 84 can be powered according to a predetermined profile. When the spring 84 is no more powered, it can be returned to its initial position by a manual action of the user, for example when the user inserts again the device 12 in the recess portion 54. This is shown in the top part of FIG. 4.

According to the second embodiment, the retaining mechanism 90 comprises a first magnetic element 91 which is able to interact with a second magnetic element 92 integrated into the device body 21 to retain the battery end 22 of the device 12 within the recess portion 54. Each of these magnetic elements 91, 92 is for example formed by a permanent magnet arranged facing each other when the aerosol generating device 12 is received in recess portion 54. Particularly, the second magnetic element 92 is arranged in such a way that its extremity facing the external surface of the first magnetic element 91 has the opposite polarity. In other words, the first magnetic element 91 is arranged to attract the second magnetic element 92. In some other embodiments, each the magnetic elements 91, 92 may be formed by any other magnetic element like an electromagnet.

It is also clear that in some embodiments, the retaining mechanism 90 as disclosed in relation with the second embodiment can be used in combination with the ejecting mechanism 80 as disclosed in relation with the first embodiment. In such a case, this ejecting mechanism 80 can exert for example only the repelling action, without the retaining action. For this purpose, the ferromagnetic element 83 can be supressed.

### THIRD EMBODIMENT

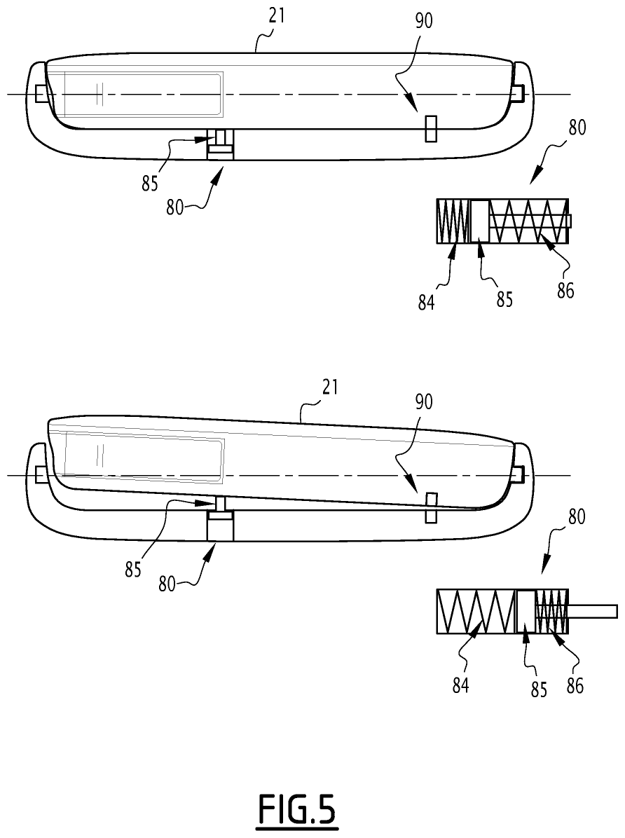

According to the third embodiment shown in FIG. 5, the ejecting and retaining mechanisms 80, 90 are similar to those explained in relation with the second embodiment.

The only difference of the third embodiment is that the ejecting mechanism 80 according to this embodiment further comprises a biasing element 86 configured to bias the shape memory alloy spring 84 to its initial position after having been expanded. This biasing element 86 presents for example a spring arranged according to the same axis as the shape memory alloy spring 84 and able to exert a repelling force to the shape memory alloy spring 84 when this last is expanded. Particularly, the biasing element 86 is configured to exert a repelling force which is less than the extension force of the shape memory alloy spring 84 when it is powered. When the shape memory alloy spring 84 is not powered, the repelling force of the biasing element 86 biases the shape memory alloy spring 84 to its initial shape. Thus, no manual user action is necessary in this case to bring the shape memory alloy spring 84 into its initial shape.

### OPERATION METHOD

It is considered initially that the aerosol generating device 12 is received in the recess portion 54 of the charging unit 14 as it is shown in the top parts of FIGS. 3 to 5. When the user wishes to extract the aerosol generating device 12 from the charging unit 14, he/she may cause a trigger event by actuating for example the button 77 and/or by launching the authentication process. The trigger event is detected by the control module 75, which activates the ejection mechanism 80. At least one end of the device body 21 is ejected from the recess portion 54 is it shown in the bottom parts of FIGS. 3 to 5. The user may thus grab the aerosol generating device 12 and start to use it by making for example a puff.

1. A charger configured to operate with an aerosol generating device; that includes
a device body extending along a first axis between two ends, the device body defining at least one lateral wall of the aerosol generating device,
the charger comprising:
a housing defining an external surface and a recess portion formed in the external surface and configured to receive the aerosol generating device so as the lateral wall of the device body extends continuously with the external surface of the housing; and
an ejecting mechanism configured to eject of the aerosol generating device from the recess portion of the charger in response to a trigger event.

2. The charger of claim 1, wherein the trigger event comprises activation of a button by a user.

3. The charger of claim 1, wherein the trigger event comprises a successful authentication of a user.

4. The charger of claim 1, wherein
the ejecting mechanism is configured to be powered in response to the trigger event to eject the aerosol generating device;

5-15. (canceled)

16. The charger of claim 4, wherein
the ejecting mechanism is configured to be powered during a predetermined time period to maintain the aerosol generating device in an ejected position.

17. The charger of claim 1, further comprising:
a retaining mechanism configured to retain the aerosol generating device within the recess portion of the charger.

18. The charger of claim 17, wherein
the retaining mechanism comprises a ferromagnetic element or magnetic element arranged in the housing so as to create attraction with a magnetic element comprised in the device body.

19. The charger of claim 1, wherein
the ejecting mechanism comprises a first magnetic element arranged in the housing to face a second magnetic element arranged in the device body.

20. The charger of claim 19, wherein
the first magnetic element is configured, when powered, to repel the second magnetic element.

21. The charger of claim 20, wherein
the first magnetic element is a coil configured to generate a magnetic field repelling the second magnetic element.

22. The charger of claim 21, further comprising:
a ferromagnetic element arranged in the housing and configured to retain the aerosol generating device within the recess portion of the charger by creating attraction with the second magnetic element comprised in the device body.

23. The charger of claim 22, wherein
the ferromagnetic element of the retaining mechanism forms an electromagnetic core of said coil of the ejecting mechanism.

24. The charger of claim 23, wherein
the ferromagnetic element is configured to retain the device body within the recess portion of the charger when the ejecting mechanism is not powered.

25. The charger of claim 1, wherein the ejecting mechanism comprises:
a shape memory alloy spring configured to expand when powered; and
a plunger mounted on the spring and configured to repel one end of the aerosol generating device.

26. The charger of claim 25, further comprising:
a retaining mechanism configured to retain the aerosol generating device within the recess portion of the charger, wherein
the retaining mechanism is configured to retain a non-ejected end of the aerosol generating device within the recess portion of the charger.

27. The charger of claim 25, wherein
the ejecting mechanism comprises a biasing element configured to bias the shape memory alloy spring to its initial position after having been expanded.

28. An aerosol generating system, comprising:
an aerosol generating device comprising a device body extending along a first axis between two ends, the device body defining at least one lateral wall of the aerosol generating device; and
a charger comprising
a housing defining an external surface and a recess portion formed in the external surface and configured to receive the aerosol generating device so as the lateral wall of the device body extends continuously with the external surface of the housing; and
an ejecting mechanism configured to eject the aerosol generating device from the recess portion of the charger in response to a trigger event.

29. The aerosol generating system of claim 28, wherein
the aerosol generating device comprises a user interface.

30. The aerosol generating system of claim 29, wherein the user interface is configured to display at least one of the following:
an indicator indicating whether the aerosol generating device is received within the charger;
an indicator indicating a charging process of the aerosol generating device by the charger;
an indicator indicating results of an authentication process;
an indicator indicating progress of heating of a vaporizable material;
an indicator indicating a remaining capacity of heating the vaporizable material without charging of a battery comprised in the aerosol generating device;
an indicator indicating a remaining capacity of the battery of the aerosol generating device;
an indicator indicating the remaining capacity of a battery of the charger; and
an indicator indicating a charging process of the battery of the charger by an external power source.

31. An operation method of an aerosol generating system including an aerosol generating device having device body defining at least one lateral wall, and a charger including a housing defining an external surface and a recess portion formed in the external surface and configured to receive the aerosol generating device so as the lateral wall of the device body extends continuously with the external surface of the housing and an ejecting mechanism configured to eject of the aerosol generating device from the recess portion of the charger in response to a trigger event, the method comprising:
detecting the trigger event; and
providing power to the ejecting mechanism of the charger to eject the aerosol generating device from the recess portion.
